(19) United States
(12) Patent Application Publication
(10) Pub. No.: US 2025/0063013 A1
(43) Pub. Date: Feb. 20, 2025

(54) SYSTEM AND METHOD OF GEOFENCED EVENT BASED INDIVIDUALIZED NETWORKING AND USER PAIRING

(71) Applicant: Bianca Samone Ross, Atlanta, GA (US)

(72) Inventor: Bianca Samone Ross, Atlanta, GA (US)

(21) Appl. No.: 18/234,512

(22) Filed: Aug. 16, 2023

(51) Int. Cl. H04L 51/52; G06Q 50/00; H04L 67/306; H04L 67/52

(52) U.S. Cl. CPC H04L 51/52; G06Q 50/01; H04L 67/306; H04L 67/52

(57) ABSTRACT

The current invention pertains to a system and method of geographically bounded matchmaking between singles within a set pool of potential matches. Many dating applications focus primarily on geographically bounding matches, however they do so in a general sense by tagging a user's location, then applying a user established radius and presenting potential matches based off of their location in that radius and the initial user's location within the presented matches parameters. The present system differs greatly in that the geographical location is based on an event, and the pool of potential matches is determined by establishing other individuals attending the same event. When two people are in the same place, matching allows for quick interaction and meeting. Furthermore, integration with pre-planned events allows for a greater degree of integration into the management of the event itself, as well as a shorter lead time and instant gratification in meeting a match immediately. The present invention demonstrates further utility in that it presents a safer alternative to meeting with strangers alone, preventing a number of potentially dangerous behaviors, and allowing for the platform to exercise a greater degree of control in order to assure user safety.

### BACKGROUND OF THE INVENTION

Since the advent of the internet, more and more people are meeting friends and partners online. Most of today's networking applications include pairing functionalities for a wide variety of romantic and nonromantic relationship establishment. While incredibly useful in terms of building social networks, these relatively anonymous applications come with a number of inherent risks typically associated with meeting strangers. The transition from having a digital discussion to meeting in real life can be jarring as compared to the traditional means of in-person networking. It is also the moment of truth when it comes to determining if a digital match can become a legitimate connection. In order to help soothe the transition and continue to improve upon the technology driven networking application revolution, the present invention discloses a means of combining traditional network building events with the use of a digital application which allows for the employment of compatibility algorithms, detailed record keeping, and facilitating the formation of a connection between two or more individuals.

### BRIEF DESCRIPTION OF THE DRAWINGS

FIG. 1 shows the process by which a pool of users is created. First, interest in an event is gauged by notifying users of an event location and its relevant timing. Then, the system determines attendance at said event, generating a pool of eligible users based on attendance so that only present parties are included in the user pool.

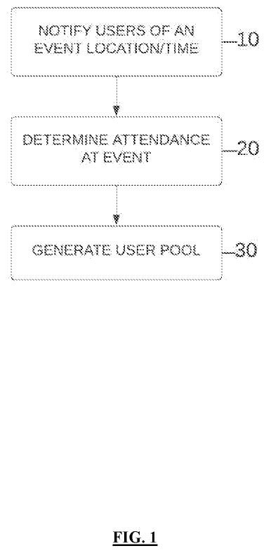

FIG. 2 shows the process by which a generated pool of users is paired with other users. First, compatibility is assessed, then a two-step process of users liking each other either confirms or denies a connection. If a connection is confirmed, the users are allowed to communicate and ultimately confer benefits via attendance at the event.

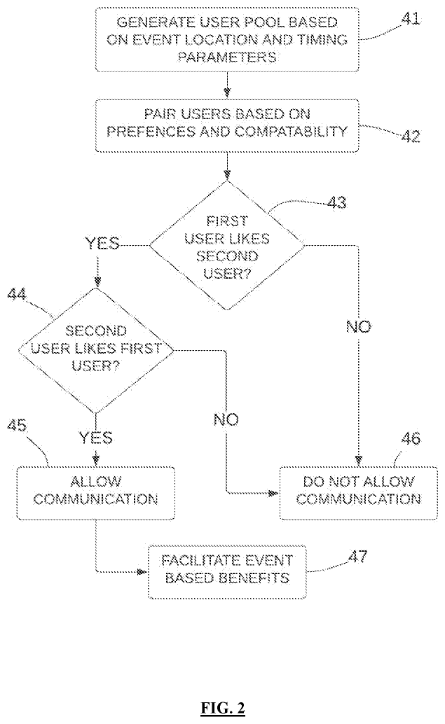

### DETAILED DESCRIPTION

Internet based networking and matchmaking poses numerous advantages over traditional forms of meeting new people. Convenience is a major factor, but there are other benefits as well. Connecting electronically through a registered means allows for identification of users and collection of data on an unparalleled level. When that data includes geolocation information, the data's value increases dramatically in terms of both commercial and monetary assessments. This also provides the opportunity to realize intangible benefits, such as the promotion of safety or efficiency.

Even with global positioning system technology and personal identifying information being collected by a platform that facilitates meeting new people, making the transition from a digital device to a real-life interaction with a stranger can be jarring and difficult. There are many inherent and legitimate concerns when it comes to meeting strangers. First, it can be hard to verify that they are who they say they are regardless of what parameters are used. Collecting driver's license data or payment information can be useful, but even the most complicated screening systems are not one hundred percent effective. Second, agreeing upon a place to meet that makes both parties feel safe can cause friction. Third, there is a significant likelihood that if a match does not go well, that both the time and effort spent on getting prepared and going to an event amount to a waste if the initial lack of connection is apparent within moments of meeting each other in person. For all of these reasons and more, users of social networking and pairing applications are often hesitant to take things from the digital world into the real one. As an added safety benefit, the present system allows for individuals to attend events in groups, even when seeking one on one connections, which is much safer than meeting a stranger by oneself.

By bringing a pool of users into a single event, many of these problems can be solved. Event security can protect all the attendees at the same time, allowing for safer locations to allow for meetings to occur. Furthermore, when numerous users are all present, a lack of connection does not render the entire exercise futile. If a user group with multiple other potential matches is located at the same event, there is the potential to try a second or third time when things do not go right initially with the first match. Otherwise, a user might give up and go home after just one bad match. While traditional events cater to traditional forms of attendance, events optimized through this specific type of computing system and architecture have the potential to substantially improve the existing state of digital social networking and matchmaking in general.

There is also the potential to cater event specific benefits to each user through the use of the contemplated system and method. One example, which is not in any way intended to be exhaustive, is that a bar associated with an event may allow one user to buy another an alcoholic beverage directly from the bar. This is an updated form of the classic act of having the bartender bring another a drink and acknowledging the sender, however it has the added benefit of avoiding unwanted suitors and unwanted beverages. When the beverage in question is delivered directly by the establishment, the second user can also be sure that it has not been laced or otherwise tainted. The same model can be applied to a number of other goods and services being offered in connection with any event, such as private rooms or sections, consumption of food or drink, or providing for certain forms of entertainment such as games or movies. These individual transactions will allow event hosts to sell a broader range of goods and services directly to attendees of events to facilitate getting to know one another while also gaining unparalleled insights into what their guests enjoy and what they avoid.

The potential to market directly to a venue attendee user pool in real time is a serious benefit to event coordinators and hosts, as it gives insight and control by allowing them to provide buying decisions directly to those users. A vast majority of purchasing decisions are made while on location, with more than half of shoppers reporting that the make an impulse buy with each trip to a store. Advertising within businesses accounts for a significant increase in revenue, which is why so many consumers are confronted with printed advertisements at each establishment that they visit. Applying the model to a digital platform creates the chance to avoid many of the pitfalls of traditional digital advertising. Avoiding the traditional pitfalls allows for a more accessible and cost-effective way for event-based businesses to initiate digital advertising campaigns.

Digital advertising in its current form is wildly inefficient and difficult to track. Most paid digital advertising follows a concept known as a funnel. Advertising dollars in a funnel are targeted at generating brand awareness that the advertiser can use to drive conversions which result in the exchange of monetary value for a user's desired product after a certain number of impressions. The first step is generating awareness, which may require multiple advertisements across multiple platforms, and which theoretically leads to interest. Interest hopefully leads to desire, at which point a customer them seeks out the advertisers and ultimately acts, finally giving the advertiser a return on the advertising investment. The problem is, building a funnel is more art than science. It is impossible to guarantee any success and difficult to attribute what portion of sales are attributable to what portion of the advertising the consumer interacted with. Stationary non targeted advertising is by and large a waste. Nonvisual advertisements such as radio and podcasts do not drive attentiveness. Social media advertising results in competition for attention and the paying of inflated advertising costs. Emails are mostly ignored or forwarded to spam. Alternatively, advertising services or goods at the event where they are to be consumed provides the opportunity to realize value immediately and can even be facilitated on the same platform immediately.

Functionality that allows for the immediate conversion of those leads into sales not only allows advertising spending to immediately return a benefit, but it also allows for the collection of insights into each individual consumer's purchasing habits. User preferences for specific goods or services can be recorded and tracked across multiple events to create user profiles. Those profiles may include suggestions for specific types of drinks or foods or specific types of experiences, as well as compatibility. Businesses will be able to directly advertise to users they know are more likely to make purchases from them based on previous buying habits. Businesses can also refine their own services to attract users outside their typical client base, bringing in new customers while giving those user groups more events to attend. Furthermore, brands that are associated with the event space or broadly associated with the user group that is common across multiple events will be able to reach their target audience at the places they make purchases. This is especially true for events that include alcohol in terms of the brands of alcohol they sell, however it can also apply to numerous other products ranging from events to clothing.

Ultimately, the specific implementation of the current system and method of utilizing a geofenced event based individualized networking and user pairing into computer architectures designed to provide platforms for strangers to meet is both totally novel and extremely useful. The progress in terms of safety and efficiency will be great, and the advertising and data collection implications will be lucrative. Users will be able to meet other likeminded and compatible users in low pressure event-based settings that also allow for the easy and efficiency consumption of the host's goods and services. By limiting a user pool to a specific attendance-verified and event-based application, the present invention removes the distance in digitally meeting strangers while extracting the fear of rejection from approaching a stranger in person. In due course, use of the platform benefits users, advertisers, and hosts alike.

1. A method of real time matchmaking, comprising:
establishing a specialized database of user online-dating profiles;
establishing a venue bounded by geolocation data;
providing a graphical display of other users present within the geolocation parameters to view the pool of other users present;
determining that the first user has expressed a positive preference decision in regard to a second user;
determining that a second user has expressed a positive preference decision regarding the first user after determining that the first user expressed the positive preference indication regarding the first potential match; and
providing a means for the first and second users to communicate with one another.

2. The method of claim 1, in which the method further comprises a means for users to purchase goods or services in connection with the venue.

3. The method of claim 1, in which the method further comprises a means for preventing communication with any user who expresses a negative preference indicator.

4. The method of claim 3, in which the method further comprises a means for reporting users who behave inappropriately to venue security staff.

5. The method of claim 1, in which the event is further bounded in terms of date and time.

6. A system of profile matching between real time attendees within a venue comprising:
establishing a single set of geolocation parameters in correlation with a venue;
establishing a plurality of user online-dating profiles that meet the set of geolocation parameters;
electronically receive a first request for pairing with a first user by way of an electronic device;
determining a set of potential matches from the plurality of other user online-dating profiles that meet the set of geolocation parameters;
allowing for the first user to indicate a positive of negative response as to the plurality of other user online-dating profiles;
matching users who provide positive responses to one another establishing a potential match; and
establishing a means for users who potentially match to communicate with one another via a specialized computer network.

7. The system of claim 6, in which the specialized computer network also allows for interaction with a business that operates the venue.

8. The system of claim 6 which further comprises a means for users to report inappropriate conduct within the plurality of other user online-dating profiles.

9. The system of claim 6 in which the venue also establishes a timeframe in which the plurality of other user online-dating profiles may interact.
